(19) United States
(12) Patent Application Publication
(10) Pub. No.: US 2003/0055706 A1
(43) Pub. Date: Mar. 20, 2003

(54) System and method for determining staffing needs for functions in an office

(76) Inventor: Beth Statfeld, Brooklyn, NY (US)

Correspondence Address: DICKSTEIN SHAPIRO MORIN & OSHINSKY LLP, Michael J. Scheer, 41st Floor, 1177 Avenue of the Americas, New York, NY, 10036-2714, US

(21) Appl. No.: 10/219,340

(22) Filed: Aug. 15, 2002

Related U.S. Application Data
(60) Provisional application No. 60/312,402, filed on Aug. 15, 2001.

(51) Int. Cl. G06F 17/60

(52) U.S. Cl. 705/9

(57) ABSTRACT

A system and method for determining staffing requirements in an office for the functions performed in the office. A server receives data relating to the work activity in an office; the work activity capable of being associated with the functions performed in the office. The server analyzes the data and determines the staffing requirements for each function. If the office is a bank, the functions may be a Relationship Manager, Small Business Relationship Manager, Retail Sales, and Retail Service. If the branch has a Branch Manager, the staffing requirements for the other functions are adjusted accordingly.

### CROSS-REFERENCE TO RELATED APPLICATIONS

This application claims priority to provisional application No. 60/312,402 filed on Aug. 15, 2001, the entirety of which is hereby incorporated by reference.

### FIELD OF THE INVENTION

This invention relates to a system and method for determining staffing needs at an office and, more particularly, to a system and method for determining the staffing needs of particular functions in an office.

### BACKGROUND OF THE INVENTION

When an office employs more than a minimal number of employees, it becomes desirable to forecast and/or determine staffing needs for the office. This is particularly important in large companies with many branch offices who typically determine staffing requirements (i.e., human resources) for the branch offices at a centralized location. Such a centralized location receives information relating to the operation of the branch offices and determines staffing needs in response.

Prior art systems for determining staffing needs typically only determine the total gross amount of staff needed for a particular office or create schedules for human resources already allocated to or requested at a particular location. For example, U.S. Pat. Nos. 5,111,391 to Fields et al., and 5,325,292 to Crockett disclose methods for determining schedules for employees already staffed at a particular location. U.S. Pat. No. 5,117,353 to Stipanovich et al. discloses a placement system for temporary employees. The system matches temporary employees with staffing requests from employers. However, the system does not determine any staffing needs for the employers. Similarly, U.S. Pat. No. 6,049,776 to Donnelly et al. discloses a system for choosing employees from among a pool of potential staff. However, there is no indication that the staffing needs of a particular office are ever evaluated.

Such prior art staffing techniques do not provide enough desired information. Most offices employ individuals with a plurality of different functions, each with its own skill set. A gross staffing number indicating the number of people needed to staff the office does not indicate how many people of each type of function are needed. For example, in an office where the functions performed are managerial and sales, staffing data indicating that 3 people should be staffed does not convey whether 3 managers and no salesmen, 2 managers and 1 salesman, etc. should be employed. Without this data, an office may be staffed with unqualified individuals or staffed with too many expensive overly skilled and overly qualified individuals.

Thus, there is a need in the art for a system and method which can determine staffing needs in an office and which can determine the staffing needs for each function performed in that office.

### BRIEF DESCRIPTION OF THE DRAWINGS

FIG. 1 is a drawing showing a staffing system in accordance with the invention.

FIG. 2 is a block diagram showing a flow of processes in accordance with the invention.

FIG. 3 is a block diagram showing a partial flow of processes in accordance with the invention.

FIG. 4 is a block diagram showing a partial flow of processes in accordance with the invention.

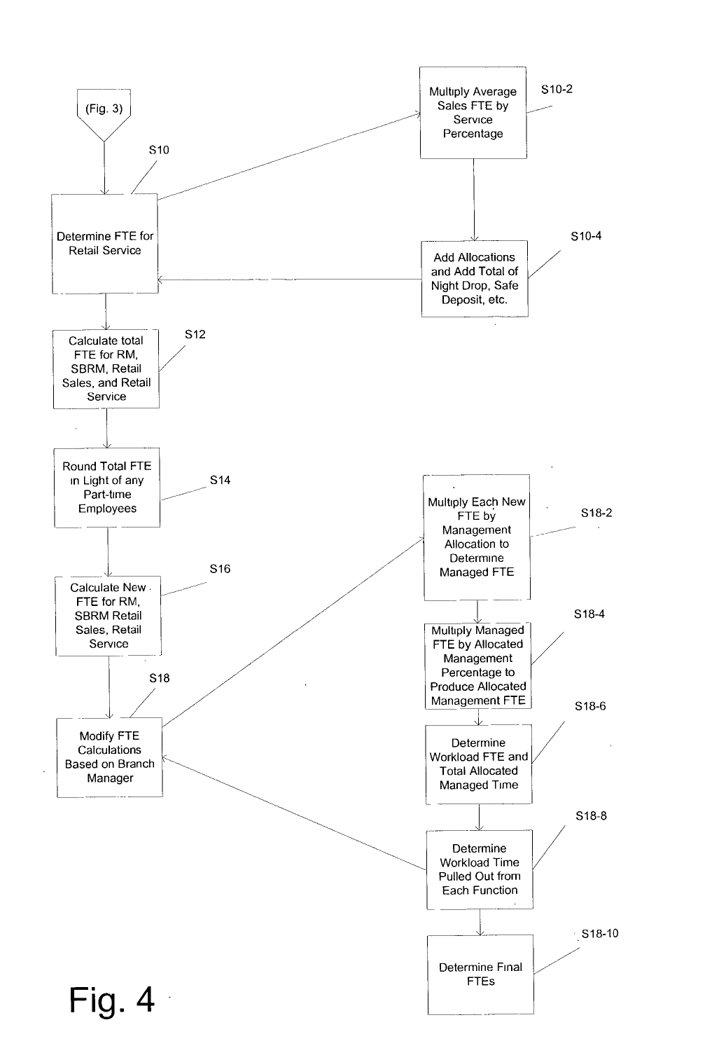

### SUMMARY OF THE INVENTION

A system and method for determining staffing requirements for an office in accordance with the particular functions performed in the office. A server receives data relating to the work activity in an office; the work activity capable of being associated with the functions performed in the office. The server analyzes the data and determines the staffing requirements for each function. If the office is a bank, the functions may be a Relationship Manager, Small Business Relationship Manager, Retail Sales, and Retail Service.

Briefly stated, the server determines sums or averages of total service and sales activity from the data. The server then determines respective proactive sales for the Relationship Manager, the Small Business Relationship Manager, and Retail Sales. The service and sales are apportioned to the functions based on assumption percentages. Allocations are then added. If the branch has a Branch Manager, the staffing requirements for the other functions are adjusted accordingly.

### DETAILED DESCRIPTION OF THE PREFERRED EMBODIMENT

### Overview

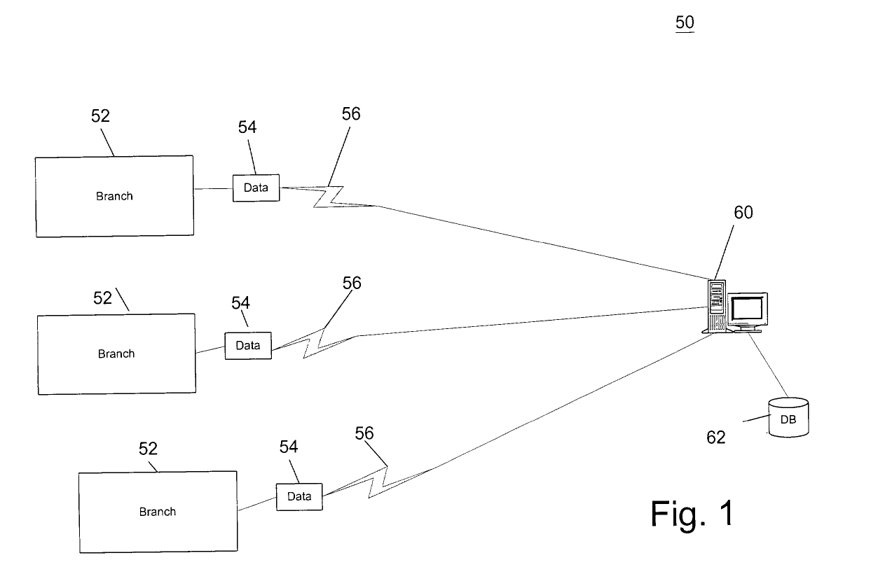

Referring to FIG. 1, there is a shown a staffing system 50 in accordance with the invention. In the system 50, branch offices 52 forward data 54 through a communication link 56 to a system server 60. System server 60 may be anything capable of performing the calculations described below; this includes, but is not limited to, a computer. Offices 52 can be, for example, branches in a bank. Clearly, only one office 52 may be used. System server 60 may be disposed at the same location as a particular office 52 or may be located remotely. Communication link 56 may be anything which conveys information from an office to system server 60. For example, communication link 56 could be, but is not limited to, a network, the Internet, wireless communication, facsimile, or even an individual manually forwarding data 54.

System server 60 receives data 54, processes data 54 using modeled parameters (discussed more completely below) stored in a database 62, and determines staffing requirements for each office 52 including staffing requirements for certain functions performed in that office. These staffing requirements are typically in full time equivalent (“FTE”) units. Each FTE unit corresponds to an employee working full time on a particular function. Typical functions which are performed in the branch office of a bank are: Branch Management, Relationship Management, Small Business Relationship Management, Retail Sales, and Retail Service. The Branch Management function typically includes the duties performed by the Branch Manager. The Relationship Management function is the duties performed by a platform officer who manages a relationship with a client (typically with balances of $25,000 or more). The Small Business Relationship Manager function is the duties performed by a platform officer who manages commercial account relationships. The Retail Sales function is the duties performed by a platform representative who helps customers open new accounts and manages relationships with clients who typically have balances below $25,000. The Retail Service function is the duties performed by platform representatives who assist clients in service transactions at a branch. These functions will be used throughout the description by way of example but clearly the invention is not limited to staffing such functions.

Data 54 includes data relating to work activity in the branch including: the sales activity at the branch, service transactions conducted, protocol fulfillment (account contacts) for Relationship Managers, Small Business Relationship Managers, Retail Sales, and Retail Service, the number of ATMs at a branch including service activity for these ATMs, the number of teller assist units at a branch, the number of wire transfers, the number of night drops including servicing those drops, and the number of safe deposit boxes rented. A description of all of these pieces of data is provided below.

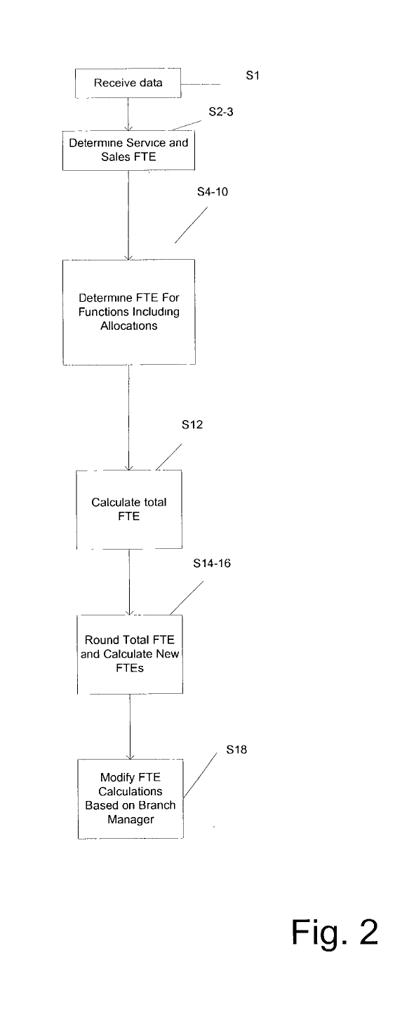

Referring to FIG. 2, there is shown an outline of the processes performed by system server 60. At Step S1, system server receives data 54. At Steps 2-3, system server 60 determines the FTE units for sales activities and service activities in the branch. These numbers may be aggregate sums or averages. At Steps S4-10, system server then determines the FTE units for all functions in the office. Such FTE calculations will include relative apportionment of the sales and service calculations made in Steps S2-3 above. Allocations are added to the FTE calculations. The total FTE units for all functions is calculated at Step S12. At Steps S14-16, the total FTE units are rounded and then New FTE calculations are made based on this rounding. Finally, at Step S18, if a Branch Manager is present at the bank, FTE calculations are modified accordingly.

A preferred model used to analyze and/or evaluate this data to produce staffing requirements and a more detailed explanation of staffing system 50 will now be explained.

### Modeling

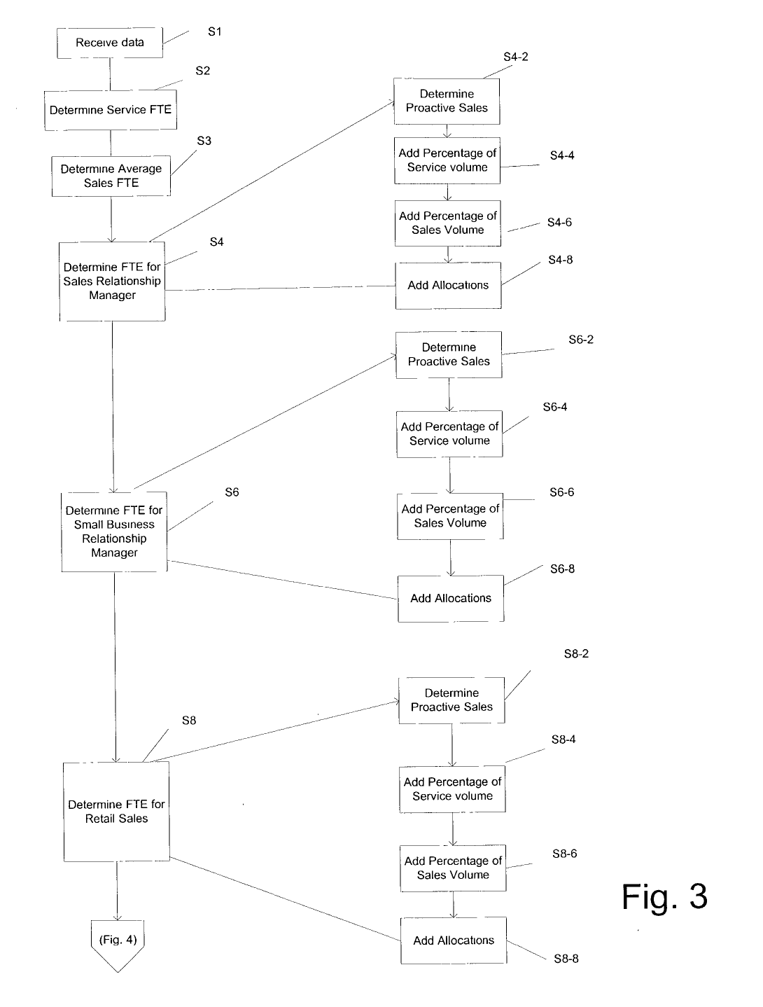

As indicated above, system server 60 processes data 54 using defined modeling parameters. The following description should be read with continuing reference to FIGS. 1-3. At Step S1, system server 60 receives data 54.

Service Activities

For service activities, data 54 includes information specifically for each branch 52 which includes service activities such as routine account maintenance, research items, customer requests, bank claims, and other activities. Data for service activities are supplied from other systems in the institution and are maintained in a database to which the system and the present invention has access. Clearly, such data may be based on proxy assumptions based on branch 52 or from direct feed data received from branch 52. A list of service activities associated with each program is provided below. One hundred and thirty-two (132) service activities may be downloaded on a monthly basis from these systems for each branch 52. All of the service transactions each have unique time standards associated therewith. The time standards for all service transactions are added up. With respect to inquiries, as there may be no data feed for inquiries, an assumption is made that such inquiries occur at a rate of 4 to 1 for all other service transactions. Therefore, the total number of service transactions is multiplied by 4 and the product is applied to the time standard associated with inquiries—referenced below. The result is added to the previously calculated hours for service transactions to produce the total hours for service transactions. Finally, the total hours is divided to produce the FTE units for inquiries.

A Table showing determined time standards for particular transactions is shown below in Tables A, B and C.

TABLE A

| Activity Group | Activity Standard (Min) |
|---|---|
| Account Adjustments | 9.51 |
| ATM Claims | 9.56 |
| CD Maintenance Requests | 10.01 |
| Foreign Currency Orders | 3.46 |
| Interest Adjustment Request | 5.00 |
| Lost ATM Cards | 7.02 |
| Masterdebit Merchant/Bank Claims | 6.52 |
| Photocopies | 3.17 |
| Telephone Message* | 6.28 |
| 1099 Corrections | 4.57 |
| Unposted Items | 9.54 |
| Inquiry | 1.87 |

*There are 97 different types of Telephone messages captured.

TABLE B

| Activity | Time Standard (Min) |
|---|---|
| Copy of 1099 Form | 3.17 |
| Copy of Checks | 3.3 |
| Copy of Return Item | 2.79 |
| Copy of Signature Card | 2.22 |
| Copy of Statement | 3.3 |

TABLE C

| ATC | | Time Standard |
|---|---|---|
| Code | Activity Name | (Min) |
| 1002 | CIF MAINT | 6.88 |
| 1101 | NEW ACCT-IM | 3.48 |
| 1102 | IM ACCT MAINT-CUST | 4.69 |
| | RELATED | |
| 1103 | IM ACCT MAINT-NONCUST | 3.48 |
| | RELATE | |
| 1104 | IM ACCT TYPE MAINT | 4.24 |
| 1105 | IM FEE WAIVER MAINT | 0.6 |
| 1107 | IM SVC VOLUME MAINT | 3.48 |
| 1108 | IM ACCT AUTO TRANSFER | 4.22 |
| | MAINT | |
| 1201 | NEW ACCT-ST | 3.48 |
| 1202 | ST ACCT MAINT-CUST | 3.48 |
| | RELATED | |
| 1203 | ST ACCT MAINT-NONCUST | 3.48 |
| | RELATE | |
| 1205 | ST FEE WAIVER MAINT | 0.6 |
| 1206 | CD CONVERSION | 6.29 |
| 1207 | RETIREMENT CONVERSION | 6.29 |
| 1209 | RMF MAINT | 3.48 |
| 1301 | ADD CRF CARD | 5.00 |
| 1302 | CRF MAINT-CUST | 3.48 |
| 1303 | CRF MAINT-CARD/ACCT | 3.48 |
| 1304 | CRF MAINT-PIC CHANGE (PIN) | 5.08 |

Other Branch Service Activities

Other branch activities contribute to branch staffing requirements and are discussed below.

For safe deposit box activity, system server 60 receives data 54 including information relating to the number of rented boxes for a particular branch 52. Average monthly access rates range from 4 to 23 percent. An average of 19 percent of rented boxes being accessed is therefore used in the model. Each safe deposit box access takes an estimate of 6.5 minutes. These numbers are used to calculate the needed FTE to service safe deposit boxes.

For ATM service allocation, system server 60 receives data 54 including information relating to the number of ATMs per branch 52. ATM servicing is performed by a Platform (i.e. one of a Branch Manager, Relationship Manager, Small Business Relationship Manager, Retail Sales person, and Retail Services person) and a client associate (e.g. a teller) representative. This activity is divided into morning and afternoon “time of day” scheduled activity. The activity itself includes envelope removal, machine maintenance and cash replenishment. Each branch is allocated a time standard of 22 minutes per day per ATM for total servicing.

Night drop servicing activity, like ATM servicing, is performed by a Platform and client associate representative. Data 54 includes the number of night drops processed for a particular branch 52. This activity is also a “time of day” scheduled activity in the model and is defined as the removal of the night bags from the vault and the logging of these bags. A time standard of 72 minutes is then applied for each bag dropped.

Money wire transfers include data input and approval. Data 54 includes information relating to the number of wire transfers completed per branch. The actual volumes are updated monthly and in designated branches the data input is allocated in the client associate model. A time standard is then applied for each computer system into which wire transfer requests are input. For security reasons, the request is input by one individual and approved by another. The time standard may be broken down into input of the wire data—239 seconds—and approval of the wire data—124 seconds.

For teller assist units (i.e. cash dispense units for use exclusively by a teller), system server 60 receives data 54 including information relating to the number of teller assist units per branch 52. A time standard of 5.7 minutes daily for servicing is then applied for each machine.

At Step S2, system server 60 determines the total number of service FTE units reasonably required to support the service activities of a branch represented in data 54.

Sales Activities

In the sales activities portion of the model, system server 60 receives a periodic (i.e. monthly) data feed of data 54 relating to all sales activities in each branch 52. These numbers are converted to an average weekly number by dividing the total sales number by the number of business days in the month and multiplying by five. Sales activity volumes are then associated with determined time standards discussed below. A weighted average transaction time is derived from the volumes and time standards for each branch. These volumes are spread evenly over an average week. The time standards for many types of transactions are determined as is shown below in Table II.

TABLE II
Time standard for Sales Activities

| | Time standard |
|---|---|
| Transaction | (Hours:minutes:seconds) |
| Better Banking | 0:22:05 |
| Business CD | 0:24:40 |
| Business Checking | 0:22:55 |
| Business Loan Application | 2:01:46 |
| Business Loan Booked | 0:25:00 |
| Branch Based Insurance | 0:29:20 |
| Branch Based Investments | 0:26:20 |
| Business Savings | 0:26:49 |
| Continental Debit Card | 0:6:43 |
| CIA Credit Insurance | 0:6:43 |
| CIS Referral | 0:26:20 |
| Flat Fee Checking | 0:26:40 |
| Home Equity Application | 0:48:46 |
| Home Equity Booked | 0:20:00 |
| Life Line Checking | 0:26:05 |
| Merchant Service Referral | 0:6:43 |
| Online Banking Application | 0:6:43 |
| Personal CD | 0:25:48 |
| Personal Group Sales | 0:22:05 |
| Personal Loan Application | 0:39:52 |
| Personal Loan Booked | 0:21:15 |
| Personal Savings | 0:17:15 |
| Revolving Credit Application | 0:6:43 |
| Select Checking | 0:36:09 |

At Step S3, system server 60 determines the average length of a sales session for the previous month's sales, and the average volume for a week. For example, an average sales session may be 27 minutes and average volume may be 117 sales for an average sales FTE of 1.37. This is based on a 40 hour work week.

Proactive Sales

In a typical branch of a bank, managers are required to spend time contacting certain customers. To staff for management time, system server 60 receives in data 54 information relating to the number of customers per tier for each branch. The modeling of management time includes an estimate of outbound contacts by Relationship Managers of: one contact per quarter for Tier 1 (i.e. high balance customers) and Tier 2 (i.e. customers with a lower balance than those in Tier 1) retail customers; two contacts per year for Tier 3 retail customers; and one contact per year for Tier 4 retail customers. For Small Business Relationship Managers, there is an estimate of one outbound contact per quarter and two contacts per year at the place of business for Tiers 1-5. For employees in Retail Sales, there is an estimate of one outbound contact per year for Tier 5 retail. The model includes an estimate that each telephone contact is 20 minutes and each place of business contact is 75 minutes. Using the actual number of customers at a branch and the above described monthly assumptions, system server 60 determines the number of weekly contacts needed for each branch, and uses the predetermined time standard to calculate the number of FTE units needed for proactive sales (i.e. Relationship Manager, Small Business Relationship Manager, and Retail Sales) at a particular office 52—as is shown in Steps S4-2, S6-2 and S8-2.

For example, if data 54 indicates a particular office has 85 telephone contacts which should be reached by a Relationship Manager, and each one of those contacts takes 20 minutes, then 28 hours (85*0.3 hours) are needed for the Relationship Manager function in that office. If a 40 hour work week is used, then an FTE of 0.74=(28/40) of a Relationship Manager function is needed. Similar calculations are performed by the Small Business Relationship Manager and for Retail Sales as shown below.

Relationship Manager protocol FTE-example

| Time per contact | Number of Contacts | RM Hours | FTE |
|---|---|---|---|
| 20 | 85 | 28 | 0.74 |

Small Business Relationship Manager protocol FTE-example

| Time per contact | Number of Contacts | SBRM Hours | FTE |
|---|---|---|---|
| 48 | 22 | 18 | 0.46 |

Retail Sales protocol FTE-example

| Time per contact | Number of Contacts | Retail Sales Hours | FTE |
|---|---|---|---|
| 15 | 29 | 7 | 0.19 |

Average Sales FTE-example

| Time per contact | Number of Contacts | Average Sales Hours | FTE |
|---|---|---|---|
| 27 | 117 | 53 | 1.37 |

The Averages Sales FTE is calculated by: (time per contact=27)*(number of contacts=117)=3159 minutes/60=52.65 hours/40=1.37 FTE units.

Each one of the functions of Relationship Manager, Small Business Relationship Manager, and Retail Sales further receive a portion of the calculation of other branch activities as is discussed below.

Apportioning Sales and Service Volume

Using the total amount of service FTE functions from Step S2 and the average sales FTE functions from Step S3, the FTE units are apportioned to corresponding job functions using functionality assumptions as is shown in the Table III below (i.e. Steps S4-4, S6-4, S8-4, S10-2, S4-6, S6-6, and S8-6). Preliminary FTE units for the Relationship Manager, Small Business Relationship Manager, and Retail Sales functions are then the proactive sales plus the portions allocated for sales and service. The Preliminary FTE for the Retail Service function is merely the average sales FTE (1.37 in the example) multiplied by the appropriate percentage in Table III.

TABLE III
Functionality Assumptions

| | | | | |
|---|---|---|---|---|
| Number of | | Small Business | | |
| employees in | Relationship | Relationship | Retail | Retail |
| branch before | Manager | Manager | Sales | Service |
| staffing | percentage | percentage | percentage | percentage |

Serivce

| | | | | |
|---|---|---|---|---|
| 0-5 | 20 | 10 | 20 | 50 |
| 5-10 | 15 | 10 | 15 | 60 |
| Over 10 | 10 | 5 | 15 | 70 |
| Sales | | | | |
| 0-5 | 40 | 10 | 50 | 0 |
| 5-10 | 30 | 5 | 65 | 0 |
| Over 10 | 24 | 5 | 71 | 0 |

Continuing with the Example, assume that the total service FTE from all services is 3.30. (This is calculated by summing all of the service transaction and their associated times and dividing by 40).

Further assuming that the branch in the example is between 5-10 employees before staffing then the preliminary FTE is:

Preliminary FTE-example

| | Small Business | | |
|---|---|---|---|
| Relationship | Relationship | | |
| Manager | Manager | Retail Sales | Retail Service |
| 1.65 = | 0.86 = | 1.58 = | 1.98 = |
| 0.74 + (3.3 * | 0.46 + (3.3 * | 0.19 + (3.3 * | 3.3 * 0.60 |
| 0.15) + (1.37 * | 0.10) + (1.37 * | 0.15) + (1.37 * | |
| 0.3) | 0.05) | 0.65) | |

Time Allocations

After the Preliminary FTE units are determined for each job function, in Steps S4-8, S6-8, S8-8, 10-4, some time allocations are added for other activities.

Administration Activity—The model includes non-customer activity forms filled out by platform staff including Relationship Managers, Small Business Relationship Managers, Retail Sales and Retail Service by estimating the time spent performing: report preparation; charge-off accounts; audits; fraud & investigations; research; U.S. mail; inter-office mail; electronic mail; reviewing and developing new procedures and changes in policies; external meetings; signature guarantee; notary; vault duty; and report reviews including: overdrafts/uncollected; significant balance change; returned items; CD maturity; dormant activity; status change; and new accounts. Therefore, once the number of Full Time Equivalent units are determined, the model adds an additional 8% of the FTE units allocated for each function for administrative time.

Management Activity—Management time includes time used to manage staff and be managed by a manager and coaches(i.e. employees hired at the district level whose primary job is to coach various employees on their job functions and requirements; there is typically a coach for the Relationship Managers, a coach for the Small Business Relationship Managers, etc.). The total time estimate for each of the following activities was estimated at less than 3%: coaching platform staff, performance reviews, scheduling and reviewing attendance, internal meetings and teleconferences. To compensate for management time, 12.5% of the determined FTE units for each function is added.

Absence allowance—Absence time includes vacation time, sick time, and training time. A 15% allowance is allocated for Platform staff absences. For example, the following days of vacation/absence are estimated per year: 20 vacation days, 5 personal days, 3 sick days, and 10 training days. The allocation of 15% equates to 8 weeks vacation per year per FTE. Therefore, an additional 15% is added to the determined amount of FTE units for each function.

Telephone calls—For incoming telephone calls, ten telephone calls per day are allocated for each proposed full time employee. Each call is estimated at an average of three minutes per call which is 7% of a full time employee or 30 minutes per day. Therefore, 7% is added to the total FTE units for each function.

For Retail Service, the total amount of FTE units for Night Drop, Safe Deposit Servicing, ATM, Wire Input, and Wire Output is added to the Retail Service FTE. In the example, this figure is 0.35.

Continuing with the Example, the FTE Plus Allocations Becomes:

FTE plus allocations-example

| | Small Business | | |
|---|---|---|---|
| Relationship | Relationship | | |
| Manager | Manager | Retail Sales | Retail Service |
| 2.31 = | 1.20 = | 2.21 = | 3.12 = |
| 1.65 + (1.65) * | 0.86 + (0.86) * | 1.58 + (1.58) * | 1.98 + 0.35 + |
| (0.08 + 0.125 + | (0.08 + 0.125 + | (0.08 + 0.125 + | (1.98 + 0.35) * |
| 0.15 + 0.07). | 0.15 + 0.07). | 0.15 + 0.07). | (.08 + 0.125 + |
| | | | 0.15 + 0.07). |

Rounding

Once the FTE units plus allocations are calculated for the Relationship Manager, Small Business Relationship Manager, Retail Sales and Retail service, the total FTE units for these four functions is calculated in Step S12. The total FTE number will frequently be a fraction of an FTE unit. For example, adding up the FTE numbers for the Relationship Managers, Small Business Relationship Managers, Retail Sales and Retail Service in the example produces 8.84 FTE units for a branch. Thereafter, the total FTE is rounded at Step S14.

If a part-time employee is located at that particular branch, the total FTE is rounded down to the next lowest integer and then rounded up to the next part-time employee FTE unit. A part-time employee is considered 0.65 of a FTE unit. For example, if the total FTE is 8.84, and there is a part-time employee at the branch, the FTE is rounded down to 8.0 and then rounded up to 8.65.

Otherwise, the total FTE is rounded up to the next integer—e.g. 8.84 is rounded up to 9.0. The determination of whether a part-time employee is at a particular branch may be determined using PEOPLESOFT staffing software. If the branch is determined as being a new branch, an FTE of “1” is added to the total FTE after rounding to facilitate adjustment by the new bank.

After the total FTE is rounded, a new calculation of staffing functions for Relationship Manager, Small Business Relationship Manager, Retail Sales and Retail Service functions is calculated at Step S16 to redistribute any new FTE units which were produced by the rounding. This calculation is basically the (original FTE/total FTE before rounding)*(total FTE after rounding). In the Example, the total FTE before rounding was 8.85 (2.31+1.20+2.21+3.12). The new FTE is 9 (assuming no part-time employees at the branch). Therefore, each FTE is multiplied by (9/8.85):

New FTE-example

| | Small Business | | |
|---|---|---|---|
| Relationship | Relationship | | |
| Manager | Manager | Retail Sales | Retail Service |
| 2.35 = 2.31 * | 1.22 = 1.20 * | 2.25 = 2.21 * | 3.18 = 3.12 * |
| (9/8.85) | (9/8.85) | (9/8.85) | (9/8.85) |

Branch Manager Adjustment

Once all the New FTE units are calculated for each function, the New FTE units are modified based on the presence of a Branch Manager at Step S18. A typical branch has one Branch Manager who manages all other employees. At Step S18-2, the portion of management allocated for the new FTE units are removed (i.e. each New FTE calculation is reduced by 12.5%—allocated for management). In the example the respective FTE Managed times are:

Managed FTE-example

| | Small Business | | |
|---|---|---|---|
| Relationship | Relationship | | |
| Manager | Manager | Retail Sales | Retail Service |
| 0.29 = | 0.15 = | 0.28 = | 0.40 = |
| 2.35 * 0.125 | 1.22 * .0125 | 2.25 * 0.125 | 3.18 * 0.125 |

Of these managed times, system server 60 at step S18-4 determines the percentage that each function is actually managed by the Branch Manager (“allocated managed time”) and the corresponding percentage that the employee performing a particular function is managing another individual or being managed by another individual—for example being coached. The allocated management time is calculated by multiplying the Managed FTE by an allocated managed time percentage as shown in Table IV below.

TABLE IV
Allocated Management Time Percentage

| | Small Business | | |
|---|---|---|---|
| Relationship | Relationship | | |
| Manager | Manager | Retail Sales | Retail Service |
| 40% | 40% | 60% | 60% |

The respective allocated management FTEs in the example then are:

Allocated Managed FTE-example

| | Small Business | | |
|---|---|---|---|
| Relationship | Relationship | | |
| Manager | Manager | Retail Sales | Retail Service |
| 0.12 = | 0.06 = | 0.17 = | 0.24 = |
| 0.29 * 0.4 | 0.15 * 0.4 | 0.28 * 0.6 | 0.4 * 0.6 |

System server 60 then determines at Step S18-6 the Workload FTE for each function without the allocated Managed FTE. This figure is the New FTE units calculated above minus the Allocated Managed FTE. In the example:

Workload FTE-example

| | Small Business | | |
|---|---|---|---|
| Relationship | Relationship | | |
| Manager | Manager | Retail Sales | Retail Service |
| 2.23 = | 1.16 = | 2.08 = | 2.94 = |
| 2.35 − 0.12 | 1.22 − 0.06 | 2.25 − 0.17 | 3.18 − 0.24 |

System server 60, also at Step S18-6, then determines the total allocated managed time. In this example, the total is 0.59 FTE (0.12+0.06+0.17+0.24).

Typical branches have a single full time Branch Manager. If the total allocated managed time is less than a complete FTE (as in the example) then the rest of the Branch Manager's time is distributed among the other functions and so a corresponding workload time is removed from these functions at Step S18-8. The distribution for each function is (the remainder of Branch Manager's Time)*(corresponding multiplier). The distribution is based on a workload assumption chart as shown in Table V which indicates the corresponding multipliers for each of the functions.

TABLE V
Workload Assumption Chart

| Number of | | | | |
|---|---|---|---|---|
| Employees in | | Small Business | | |
| Branch before | Relationship | Relationship | Retail | Retail |
| staffing | Manager | Manager | Sales | Service |
| 0-5 | 0.25 | 0.25 | 0.25 | 0.25 |
| 5-10 | 0.4 | 0.4 | 0.1 | 0.1 |
| 10 | 0.5 | 0.5 | 0 | 0 |

Using the example, 0.59 FTE is accounted for in the branch manager and so 0.41 FTE corresponds to the workload time to be pulled out from the four functions to produce a complete Branch Manager FTE. Assuming in the example that the number of employees in the branch before staffing is between 5 and 10:

Workload Time Pulled FTE-example

| | Small Business | | |
|---|---|---|---|
| Relationship | Relationship | | |
| Manager | Manager | Retail Sales | Retail Service |
| 0.17 = | 0.17 = | 0.04 = | 0.04 = |
| 0.41 * 0.40 | 0.41 * 0.40 | 0.41 * 0.1 | 0.41 * 0.1 |

No workload is extracted from these FTEs units if the total allocated management time for the branch manager FTE is at least equal to 1.0.

Finally, the Final FTE for the four functions is determined at Step S18-10. The Final FTE is the Workload FTE—the Workload Time Pulled. In the example:

Final FTE-example

| | Small Business | | |
|---|---|---|---|
| Relationship | Relationship | | |
| Manager | Manager | Retail Sales | Retail Service |
| 2.07 = | 1.0 = | 2.04 = | 2.9 = |
| 2.23 − 0.17 | 1.16 − 0.17 | 2.08 − 0.04 | 2.94 − 0.04 |

The FTE units for the Branch Manager are typically equal to 1.0.

General Model Parameters

The model assumes a 90% FTE utilization. A 35 or 40 hour work week may be used.

### CONCLUSION

Thus, by associating work activity with particular functions in an office and using modeling parameters to determine how each function should be staffed, staffing needs by function can be determined.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for determining staffing needs for an office having employees performing distinct functions, the method comprising:
receiving data relating to work activity in an office, the work activity capable of being associated with corresponding functions;
analyzing the data to ascertain the functions associated with the work activity; and
determining staffing needs of the office for each of the functions based on the data.

2. A method for determining staffing needs for a branch office in a bank having employees performing distinct functions, the method comprising:
receiving data relating to work activity in an office, the work activity capable of being associated with corresponding functions, the functions relating to at least a Relationship Manager, Small Business Relationship Manager, Retail Sales, and Retail Service;
analyzing the data to ascertain the functions associated with the work activity; and
determining staffing needs of the office for each of the functions based on the data.

3. The method as recited in claim 2, wherein the determining includes determining a respective number of full-time employees needed for each function.

4. The method as recited in claim 3, wherein the analyzing includes ascertaining the number of full-time employees needed for service related work activities and the number of full-time employees needed for sales related work activities.

5. The method as recited in claim 4, wherein the analyzing includes ascertaining respective proactive sales, percentage of service volume and percentage of sales volume associated with the functions.

6. The method as recited in claim 5, wherein the staffing needs for the Retail Service function are determined by apportioning a percentage of the average number of full-time employees needed for sales related work activities.

7. The method as recited in claim 5, wherein the determining further includes adding allocations for each respective number of full time employees needed for each function, the allocations including time for administration, management, absence, and telephone calls.

8. The method as recited in claim 7, wherein the determining further includes:
determining the total number of employees needed for all functions; and
rounding the total number.

9. The method as recited in claim 8, wherein the rounding includes:
rounding to the next highest integer when there are no part-time employees at the office; and
rounding to the next lowest integer and then rounding up to a part-time equivalent of a full-time employee when there is at least one part-time employee at the office.

10. The method as recited in claim 9, wherein the determining further includes calculating respective new numbers of full-time employees needed for each function after performing the rounding.

11. The method as recited in claim 10, wherein the determining further includes modifying the respective new numbers based on the presence of a branch manager.

12. The method as recited in claim 11, wherein the modifying includes:
determining management allocations included in the respective new numbers of full-time employees needed for each function;
determining respective management portions of the respective management allocations for each function;
removing the respective management portions from each respective new number of full-time employees to produce respective workload numbers; and
when the management portions do not add up to a complete Branch Manager, adjusting the workload numbers to compensate for the presence of the Branch Manager.

13. A method for determining staffing needs for a branch office in a bank having employees performing distinct functions, the method comprising:
receiving data relating to work activity in an office, the work activity capable of being associated with corresponding functions, the functions relating to at least a Relationship Manager, Small Business Relationship Manager, Retail Sales, and Retail Service;
analyzing the data to ascertain the functions associated with the work activity; and
determining a respective number of full-time employees needed for each of the functions based on the data;
wherein:
the analyzing includes:
ascertaining the number of full-time employees needed for service related work activities and the number of full-time employees needed for sales related work activities; and
ascertaining respective proactive sales, percentage of service volume and percentage of sales volume associated with the functions;
the determining includes:
adding allocations for each respective number of full time employees needed for each function, the allocations including time for administration, management, absence, and telephone calls;
determining the total number of employees needed for all functions;
rounding the total number, the rounding including:
rounding to the next highest integer when there are no part-time employees at the office; and
rounding to the next lowest integer and then rounding up to a part-time equivalent of a full-time employee when there is at least one part-time employee at the office;
calculating respective new numbers of full-time employees needed for each function after performing the rounding;
modifying the respective new numbers based on the presence of a branch manager, the modifying including:
determining management allocations included in the respective new numbers of full-time employees needed for each function;
determining respective management portions of the respective management allocations for each function;
removing the respective management portions from each respective new number of full-time employees to produce respective workload numbers; and
when the management portions do not add up to a complete Branch Manager, adjusting the workload numbers to compensate for the presence of the Branch Manager.

14. A report of staffing needs produced by the following acts:
receiving data relating to work activity in an office, the work activity capable of being associated with corresponding functions;
analyzing the data to ascertain the functions associated with the work activity; and
determining staffing needs of the office for each of the functions based on the data.

15. A system for determining staffing needs for an office having employees performing distinct functions, the system comprising:
a computer which
receives data relating to work activity in an office, the work activity capable of being associated with corresponding functions;
analyzes the data to ascertain the functions associated with the work activity; and
determines staffing needs of the office for each of the functions based on the data.
